(19) United States
(12) Patent Application Publication
(10) Pub. No.: US 2021/0070636 A1
(43) Pub. Date: Mar. 11, 2021

(54) METHOD FOR THE OPTIMIZED SOFTENING OF AN ALKALINE INDUSTRIAL EFFLUENT UNDER CO2 PRESSURE

(71) Applicant: L'Air Liquide, Société Anonyme pour l'Etude et l'Exploitation des Procédés Georges Claude, Paris (FR)

(72) Inventors: Bruno ALBAN, Verrières le Buisson (FR); Dominique BRAS, Brécey (FR); Philippe CAMPO, Montigny le Bretonneux (FR)

(21) Appl. No.: 17/015,987

(22) Filed: Sep. 9, 2020

(30) Foreign Application Priority Data
Sep. 10, 2019 (FR) 1909926

(51) Int. Cl. C02F 1/52; C02F 1/66

(52) U.S. Cl. CPC C02F 1/5236; C02F 2101/10; C02F 1/66

(57) ABSTRACT

A method for removing calcium from an industrial effluent loaded with calcium, comprises
the effluent (10) is led into a zone equipped with a settler (12);
a part of the effluent is diverted (13), part withdrawn at the settler outlet, part of between 3% and 25% of the flow exiting from the settler, part withdrawn downstream of a high-pressure pump (9), operating at a pressure typically of between 8 and 10 bars;
at least one injection (15) of gaseous CO₂ into the diverted stream is carried out, thus producing a reduction in the pH of the diverted stream within the range extending from 4 to 6.8, preferably within the range extending from 4.5 to 6;
the return of the diverted stream thus treated to the initial effluent, before its arrival in the settler, or to the settler proper is arranged.

The present invention relates to the field of the softening of highly alkalinized effluents for the purpose of neutralizing them and/or of softening them, that is to say of completely or partially removing the calcium salts present. This problem is found in particular in the iron and steel industry but other industries may be affected and mention may in particular be made of the case of the treatment of the aqueous liquors resulting from some mining effluents.

By way of illustration, the principle of the precipitation of the calcium contained in an alkaline solution (treated with lime, for example, that is to say by adding slaked lime CaOH₂ or quicklime CaO) with CO₂ is well known.

It is on this principle that particles of precipitated calcium carbonate (also known as “PCC”) are manufactured by virtue of a first stage of decarbonation of limestone, for example (production of quicklime CaO and of CO₂), followed by hydration (which produces slaked lime Ca(OH)₂), a process finally terminated by a carbonation or precipitation of the particles of CaCO₃ formed. This process makes it possible to obtain quality particles (calibrated, purified, and the like) which prove to be very useful in the field of paper pulp, for example.

It is the same for the aqueous liquors, which contain much dissolved aluminium. The significant difference between the two originates from the equilibria/forms of the molecules which contain the aluminium or the calcium and which are different. There is a tendency to precipitate the entities in question by lowering the pH in the case of dissolved aluminium (forming aluminium hydroxide Al(OH)₃), whereas it is recommended to increase the pH in the case of calcium (forming carbonates CO₃²⁻).

Thus, in the context of the present invention, we are concerned with the treatment of effluents which contain large amounts of calcium (hardness is the term used), or of magnesium, often predominantly dissolved (a suspension of particles which contain calcium may also be observed). These effluents can result in particular from the iron and steel industry.

It is known to precipitate calcium by adding carbonate ions and these in any way whatsoever, for example by injecting CO₂ into a sufficiently alkaline effluent example pH 12 to 12.5, an effluent conventionally encountered in the iron and steel industry. At this pH, the CO₂ absorbed is in the form of carbonate, which, in the presence of calcium, precipitates in the form of calcium carbonate. The optimal pH zone lies between 10 and 14, preferably between 10.3 and 12.

The carbonates can be brought about by mixing sodium hydroxide and CO₂, which can, according to the doses used, increase the final pH. The objective is to contribute carbonates to the medium, while remaining within a pH range of greater than 10.3, in order to ensure remaining in the carbonate form.

Nevertheless, the direct injection of CO₂ and thus the bringing of it into contact with the highly alkaline effluent is still difficult. This is because the CO₂ brings about, at the point of the injection, a high concentration of carbonates. These carbonates will bond with the calcium ions present and will precipitate in the injector. The formation of calcium carbonate, which is highly encrusting during its formation, will rapidly clog the injection system, will reduce its performance qualities, until will completely block it. In order to overcome this disadvantage of the direct addition of CO₂, an injection of sodium hydrogencarbonate (HCO₃⁻) or carbonate in solution is very often employed.

Nevertheless, this solution, that is to say the injection of CO₂ into an alkaline solution of sodium hydroxide type in order to have a solution of hydrogencarbonate or carbonate ions, exhibits the following disadvantages:
both water and a base, such as sodium hydroxide (the cost of which is high), are consumed,
an additional salinity is introduced into the effluent (for example, by using sodium hydroxide, sodium salts are produced).

As regards the direct injection of CO₂ into an alkaline effluent loaded with calcium or equivalent ions, unfortunately, this operation proves to be difficult to carry out for the following reasons:
the homogenization or the mixing of the effluent (liquid) and of the gas (CO₂) is not easy, that is to say not instantaneous. Consequently, the injection zone (whether an injector or a simple perforated tube, for example, is concerned), which forms the interface between effluent and gas, proves to very rapidly produce a great deal of precipitates, which cause blockages which are difficult to remove: requires shutdown and stripping with strong acid, for example.
furthermore, the particles formed prove to be fairly resistant and difficult to subsequently redissolve. They thus then often lead to blockages downstream of the injection point.
moreover, the different stages are often carried out in one and the same zone, one and the same device or pipeline, whereas the conditions required for each stage should be and are different.

Thus, to sum up, in view of the elements touched on above, the operation of injection of CO₂ can be very difficult to carry out, indeed even virtually impossible, and its application consequently abandoned by a person skilled in the art.

The Applicant Company has provided a very advantageous solution to these problems, in Application FR-1 854 872, according to which a part of the effluent is withdrawn at the settler outlet and upstream of a possible (but generally present) accelerator pump for the treated effluents in order to return them to the process or elsewhere, it is then at atmospheric pressure, it is directed, using a pump, into a zone/reactor, in which zone there has been installed a recirculation loop which makes it possible to dissolve CO₂, typically between 1 and 3 bars. A portion of this solution, highly loaded with CO₂, is then withdrawn and mixed with the initial effluent at the decanter top.

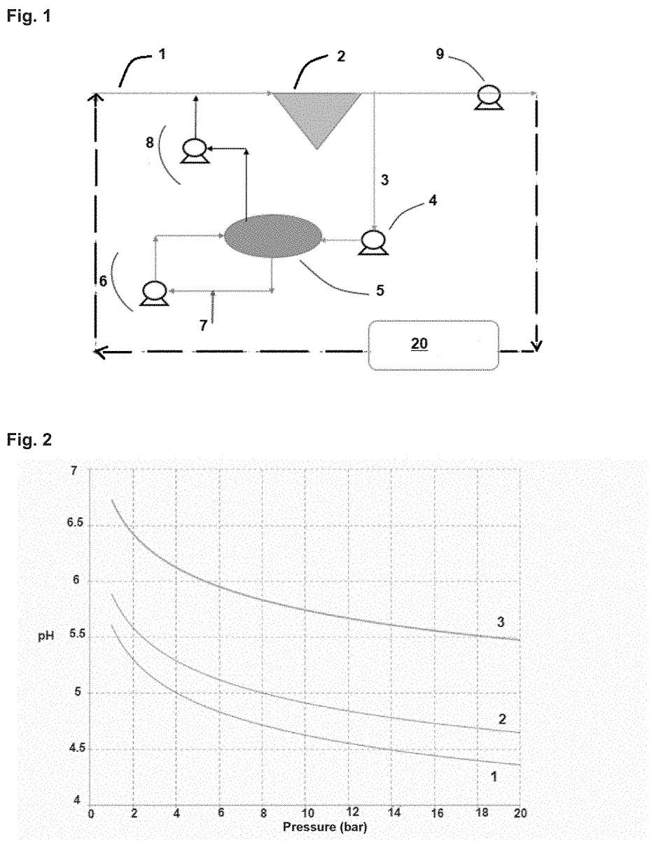

In other words, the abovementioned document describes a method for the treatment of an industrial effluent loaded with calcium and/or magnesium for the purpose of removing all or part of the calcium and/or magnesium therefrom, comprising the implementation of the following measures:
the effluent to be treated is led into a first zone, a first zone where a pH preferentially of between 10 and 12 is maintained, so as to promote the precipitation of the calcium or magnesium in the carbonate form and to thus facilitate its removal;
a second zone comprising a tank is available;
the recirculation of a part of the medium located in the zone 1 to the zone 2 and then, from there, its return to the zone 1 are arranged;
a secondary loop which makes it possible to withdraw fluid from the tank and to return the fluid to the tank, and also means making it possible to inject gaseous CO₂ into the fluid circulating in the loop, are available;
the solid particles formed in the zone 1 are separated and discharged.

[FIG. 1] appended illustrates the main elements of this prior solution:
1: the initial effluent to be treated
2: the decanter (1st zone)
3: the withdrawal of a part of the effluent from the decanter in order to send it into a second zone
4: a pump
5: tank of the second zone
6: the recirculation loop installed in the second zone
7: the injection of CO₂ into said loop
8: withdrawal, from the tank, of the solution loaded with CO₂ in order to direct it to the initial effluent at the decanter top
9: an accelerator pump for the treated effluents in order to return them to the process of the site (20).

In this prior solution, it could be considered that it was possible to technically accept an effluent still containing calcium (in a concentration range typically between 2 and 300 mg/l, but preferentially for a concentration of less than 80 mg/l), this being by virtue of the second contact zone. This is because the contact zone in this process is at a low pH, more precisely at a pH of between 5 and 6.5. At this pH, the predominant forms of CO₂ are dissolved CO₂ and hydrogencarbonate ions. The presence of carbonate ion is virtually zero, thus preventing the formation of calcium carbonate and the risk of precipitation and of blocking.

According to the present invention, a solution for improving said prior solution, in particular in order to simplify it, in that a reactor for dissolution in a second zone is not employed, is provided; in this instance, provision is made to carry out the dissolution of the CO₂ in-line.

To this end, the effluent is taken/diverted at the outlet of the settler by virtue of the intervention of a high-pressure accelerator pump which makes it possible to return the effluent treated in the process (high-pressure, i.e. typically 8 to 10 bar).

In other words, immediately after the injection of the CO₂ into the diverted stream, a state exists where the formation of carbonate is not possible and thus the risk of clogging in the pipeline and close to the injectors is thus significantly removed. The high pressure of the water in the diverted flow (typically from 8 to 10 bar) makes it possible to facilitate the dissolution of the CO₂, and to achieve high levels of concentration of dissolved CO₂, and thus to achieve conditions of low pH which prevent the risk of clogging.

[FIG. 2] appended makes it possible to illustrate this, curves 1, 2 and 3 of which Figure make it possible to display the pH which can be achieved at the saturation with CO₂ of an effluent as a function of the pressure and of the concentration of sodium hydroxide contained by the initial effluent:
curve 1: 250 mg/l sodium hydroxide solution (20° C.)
curve 2: 500 mg/l sodium hydroxide solution (20° C.)
curve 3: 4000 mg/l sodium hydroxide solution (20° C.)

It is thus observed that, for an effluent initially containing 500 mg/l of sodium hydroxide, the lowest pH which can be achieved at atmospheric pressure is approximately 5.8, whereas, at a pressure of 10 bar, it is possible to achieve a pH of approximately 4.8, thus reducing the risk of clogging and even making it possible to destroy or to redissolve possible deposits of carbonates formed previously.

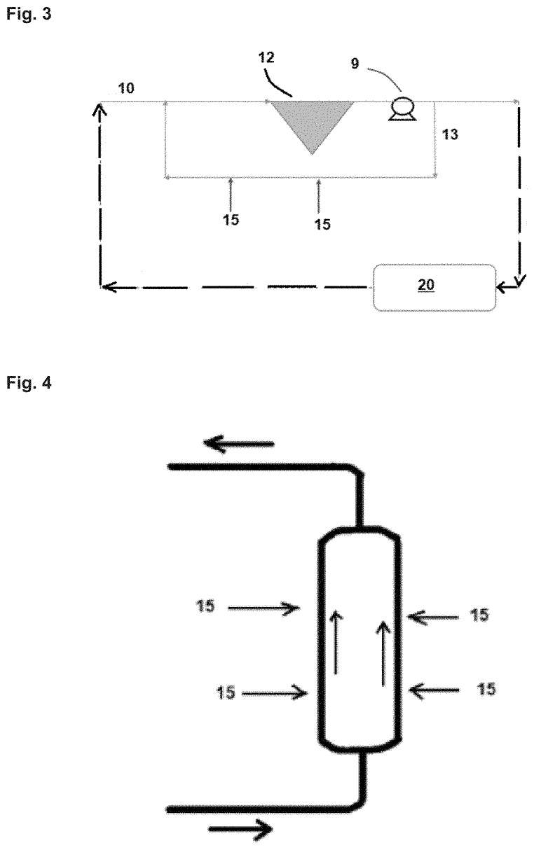

According to the present invention, and contrary to the prior solution touched on above, it is not possible to allow a “dirty” effluent, that is to say an effluent still containing a high concentration of calcium, to be recovered. This is because, in the case of high calcium concentration, there is a risk of more or less rapid clogging. With a low calcium concentration, a slow clogging at the main injector will perhaps be observed but this can be overcome by one of the advantageous embodiments of the invention where a second injection point is employed upstream of the first. This second point makes it possible, sequentially, to inject CO₂ in order to acidify and thus to unclog, if necessary, the first point. As this second point is preferentially used sequentially, for example 15 minutes per day, the risk of clogging of this second point is reduced by a factor of approximately 15 minutes out of 24 h, that is to say by approximately 99%.

[FIG. 3] appended for its part provides a partial diagrammatic representation of a plant suitable for the implementation of the present invention:
10: the initial effluent to be treated
12: the settler
13: the withdrawal (diversion) of a part of the effluent from the settler
9: a high-pressure accelerator pump
15: one or preferably more injections of CO₂ into the withdrawn flow, before returning this flow at the top into the effluent initial inlet.

The invention then relates to a process for the treatment of an industrial effluent loaded with calcium for the purpose of removing all or part of the calcium therefrom, comprising the implementation of the following measures:
the effluent to be treated is led into a zone equipped with a settler;
a part of the effluent is diverted, part withdrawn at the settler outlet, part of between 3% and 25% of the flow exiting from the settler, preferably between 5% and 10% of the flow exiting from the settler, part withdrawn downstream of a high-pressure pump, operating at a pressure typically of between 8 and 10 bars;
at least one injection of gaseous CO₂ into the diverted stream is carried out, thus producing a reduction in the pH of the diverted stream within the range extending from 4 to 6.8, preferably within the range extending from 4.5 to 6;
the return of the diverted stream thus treated to the initial effluent, before its arrival in the settler, or to the settler proper is arranged.

The invention can furthermore advantageously adopt one or more of the following embodiments:
the amount of CO₂ injected into the diverted stream makes it possible to contribute, in the carbonate form, from 80% to 100% of the stoichiometric requirement for precipitating the metals, in particular the calcium, of the stream to be treated, this after returning the treated diverted stream to the initial main stream.
the optimum amount of CO₂ to be injected is regulated from a measurement of inlet pH (effluent to be treated, before or after reintroduction of the “treated” diverted flow) or from a measurement of pH or of conductivity carried out in the settler or in the settler outlet stream.
the injection of the CO₂ into the diverted stream is carried out by a system of static mixer, or porous element, or Venturi type or other systems known to a person skilled in the art for in-line gas injections.
Said (first) injection of CO₂ into the diverted stream is carried out, and a second injection into the diverted stream is positioned upstream of the first injection, for example in order to sequentially (for example 15 minutes per day) or occasionally inject CO₂, in order to descale (if necessary) the (1^{st}) main injection point; the flow rate of CO₂ injected in this instance will then advantageously be between the minimum and maximum flow rates calculated for the main injection point.
the 1st injection is carried out continuously, or sequentially with a high frequency, preferentially several times per hour, for example at least 3 times/h.
the second injection (upstream) is carried out sequentially, with a relatively low frequency, that is to say located between 1 and 20 times per day but preferably between 1 and 4 times per day.

This is because, knowing that the injection typically takes place several hours per day, with time there is a risk, admittedly low but present, of partial clogging of the system. Using an additional injection point for CO₂ upstream of the main point, it is possible to sequence the injection (for example a few minutes per day, or also once per week or also once per month), and the effluent, thus acidified upstream of the main injection point, makes it possible to limit the risk of a possible deposition which would take place at the main injection point. This proposal of second upstream injection makes it possible, it is understood, to reduce the frequency of maintenance of the assembly.

According to another advantageous embodiment of the invention, and in particular in order to allow complete availability of the plant, it is possible to double the diversion line and the two injection points in the form of two parallel lines. One line is used permanently and the second remains in reserve; it is used in the case of maintenance of the first line.

[FIG. 4] appended illustrates such an embodiment.

The results obtained in the context of an example of industrial use are described in detail below:
determination of the minimum or stoichiometric CO₂ requirement for precipitating all (80% to 100%) of the calcium present in an effluent flow D (10): X in kg/h of CO₂.

This corresponds, for precipitating the calcium, to:
C1: Calcium concentration in g/m³
M_{Ca}: molar mass calcium
M_{CO2}: molar mass CO₂
Q: effluent flow rate.
Minimum CO₂ requirement: X=C1*Q/M_{Ca}*M_{CO2}/1000 in kg/h
calculation of the minimum effluent flow rate to be diverted D′, preferably at the settler outlet (D′=X/S, where S is the solubility of the CO₂ at the operating conditions which prevail in the diversion line, namely the temperature and the pressure).

By way of example:
An effluent with a flow rate Q=2000 m³/h
A concentration C1 of calcium which it is desired to remove of 54 g/m³
The hourly CO₂ requirement is then: X=54/40*44*2000/1000≈120 kg/h
The pressure of the effluent after the accelerator pump at the settler outlet is P=8 bar abs.
The temperature is T=20° C.
Under these pressure and temperature conditions, the solubility of the CO₂ demonstrates that it is possible to dissolve approximately 13.6 kg of CO₂ per m³ of effluent=1.7*8.

By diverting a flow rate of 10 m³/h, it is then possible to dissolve and to contribute approximately 136 kg/h of CO₂=10*13.6, i.e. an amount greater than the maximum requirement.

In order to remain always less than or equal to a pH of 6.5 in the diverted loop, it is advisable to inject at a pressure of 8 bar abs, i.e. a minimum of 25 kg/h of CO₂.

To sum up for this case, 10 m³/h are diverted, into which up to 120 kg/h of CO₂ are injected, which makes it possible to dissolve up to 136 kg/h of CO₂. A minimum amount of 25 kg/h is always injected in order for the diverted flow to be acidic.

What is claimed is:

1. A process for the treatment of an industrial effluent loaded with calcium for the purpose of removing all or part of the calcium therefrom, comprising the implementation of the following measures:
the effluent (10) to be treated is led into a zone equipped with a settler (12);
a part of the effluent is diverted (13) into a diversion line, part withdrawn at the settler outlet, part of between 3% and 25% of the flow exiting from the settler, preferably between 5% and 10% of the flow exiting from the settler, part withdrawn downstream of a high-pressure pump (9), at a pressure of between 2 and 15 bar, preferably between 3 and 10 bar and more preferentially still between 8 and 10 bar;
at least one injection (15) of gaseous CO₂ into the diverted stream is carried out, thus producing a reduction in the pH of the diverted stream within the range extending from 4 to 6.8, preferably within the range extending from 4.5 to 6; and
the return of the diverted stream thus treated to the initial effluent, before its arrivalin the settler, or to the settler proper is arranged.

2. The process according to claim 1, characterized in that a first injection of CO₂ into the diverted stream, and a second injection into the diverted stream, upstream of the first injection, are carried out.

3. The process according to claim 2, characterized in that the second upstream injection is a sequenced or occasional injection of CO₂, in order to make it possible to descale the 1st downstream injection point.

4. The process according to claim 2, characterized in that the 1st injection is carried out continuously or sequentially, with a frequency preferentially amounting to several times per hour, for example at least 3 times/h.

5. The process according to claim 2, characterized in that the second upstream injection is carried out sequentially, with a frequency located between 1 and 20 times per day but preferably between 1 and 4 times per day.

6. The process according to claim 2, characterized in that the diversion line is a line split in two in the form of two parallel lines, making it possible for one of these two lines to be used permanently, while the second line remains in reserve, for example in order to be used in the case of maintenance of the first line.
